(19) United States
(12) Patent Application Publication
(10) Pub. No.: US 2014/0198793 A1
(43) Pub. Date: Jul. 17, 2014

(54) TRAFFIC FORWARDING IN A POINT MULTI-POINT LINK AGGREGATION USING A LINK SELECTOR DATA TABLE

(71) Applicants: Ram Prasad Allu, Bangalore Kamataka (IN); Venkatavaradhan Devarajan, Bangalore Kamataka (IN)

(72) Inventors: Ram Prasad Allu, Bangalore Kamataka (IN); Venkatavaradhan Devarajan, Bangalore Kamataka (IN)

(21) Appl. No.: 14/110,511

(22) PCT Filed: Jul. 1, 2011
(86) PCT No.: PCT/US11/42747

§ 371 Date: Oct. 8, 2013

(51) Int. Cl. H04L 12/741

(52) U.S. Cl. CPC H04L 45/745
USPC 370/392

(57) ABSTRACT

A method, system and non-transitory computer-readable medium for forwarding data packet traffic in a point multi-point link aggregation using a link selector data table. A data packet is received at a device having a point multi-point link aggregation comprising a plurality of physical links. It is determined whether data extracted from the received data packet can be matched to one of a plurality of records in a link selector data table, where each record comprises data to identify a communication flow and data to identify one of the physical links, each record being generated from a data packet sampled in a transmission coming to the device along ones of the physical links. The received data packet is forwarded on the physical link identified by the one record, where the extracted data is matched to one of the plurality of records.

### BACKGROUND

In networking, a technique known as “Link Aggregation,” for example, following IEEE 802.1AX-2008 protocols, allows multiple physical network links connecting network switches and/or other devices to be treated as a single logical link. Point multi-point link aggregation schemes like Distributed Trunking (Distributed Multi-Link Trunking (DMLT)), or Split Multi-Link Trunking (SMLT), expand upon the link aggregation concept and provide that in data packet traffic forwarding a single switch or other device may be aggregated to a pair of switches for redundancy and higher bandwidth, where the switches can exist in different devices or on different hardware cards, for example.

In point multi-point link aggregation schemes data packet traffic from a switch or other device in a one layer of a layered network architecture (e.g. a layered network architecture following a model such as the OSI, Cisco or TCP/IP model) may be connected in a link aggregation to two devices in the next layer. When the device in the first layer forwards data packet traffic to the next layer, using the physical connections of the point multi-point link aggregation, the physical links are seen by the device as one logical link, but the traffic may be split across two physical links of the link aggregation. The traffic may be split between the two physical links using a scheme, such as a hashing algorithm, that selects one or the other of the physical links for forwarding data packets.

While a scheme such as a hashing algorithm may balance load between the available physical links in the link aggregation, bottlenecks can occur also when, for example, one destination device of the link aggregation (one of the devices that receives data packets), receives traffic from sender that ultimately needs to be delivered to the other device in the link aggregation.

### BRIEF DESCRIPTION OF THE DRAWINGS

Reference is made in the following detailed description to the accompanying drawings in which:

FIG. 1 illustrates an example of a point multi-point distributed link aggregation having a link selector data table;

FIG. 2 illustrates in block diagram form a point multi-point link aggregation using flow-aware link selection, according to an embodiment of the invention;

FIG. 3 illustrates record entries from a link selector data table, according to an embodiment of the invention;

FIG. 4 illustrates in a block diagram elements of a flow-aware link selection system, according to an embodiment of the invention;

FIG. 5, illustrates a process flow for building a flow table according to an embodiment of the invention;

FIG. 6 illustrates a process flow for aging-out entries in flow table, according to an embodiment of the invention;

FIG. 7 illustrates a process flow for link selection, according to an embodiment of the invention; and

FIGS. 8A-B illustrate examples of data transfer in a point multi-point link aggregation, according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

An embodiment may provide a system, method and computer-readable medium for traffic forwarding in point multi-point link aggregation topologies, using a flow-aware link selection scheme for forwarding traffic from a sending device to a receiving device in a point multi-point link aggregation.

For example, a method for link selection in a point multi-point link aggregation may include receiving a data packet at a device having a point multi-point link aggregation comprising a plurality of physical links, determining whether data extracted from the received data packet can be matched to one of a plurality of records in a link selector data table and forwarding the received data packet on the physical link identified by the one record, where the extracted data is matched to one of the plurality of records. Each record of the link selector table may include data to identify a communication flow and one of the physical links. Each record may be generated from a data packet sampled in a transmission coming to the device along one of the physical links.

A system for optimizing link selection for a point multi-point link aggregation may include a link selector data table that includes a plurality of records where each record comprises data to identify a communication flow and data to identify one of a plurality of physical links of a point multi-point link aggregation. A non-transitory computer-readable medium may have instructions stored on the medium, which when executed by a processor, may cause the processor to perform methods described herein.

A communication flow (or flow) as used herein may be a data exchange (e.g. a conversation on a wire) between two entities (people, computers, etc.) occurring through the connections of a communications network, where the data exchange transpires through the back and forth sending of data packets (packets). As packets for the flow are exchanged between the entities (e.g. sender and receiver), the communication flow, according to one example, may be defined or uniquely identified by a set of fields in the packets.

Though examples of a device using a link selector data table for link selection may be realized in many different point multi-point link aggregation configurations, in one example an access switch in an access layer of a hierarchical layered networking system may be forwarding data traffic to multiple distribution switches in a distribution layer as part of a point multi-point link aggregation. In such an example the access switch may gain awareness of the communication flows that are passing through the access switch by sampling the “downward” moving traffic of data packets arriving from the distribution layer switches to the access switch across the physical links of the link aggregation. From each sampled data packet, the access switch may extract information from the data packet to identify a communication flow to which the downwardly-received data packet belongs to or is a part of. Using information from the data packet to uniquely identify a corresponding communication flow, the access switch may construct a flow table to associate the identified communication flow with the physical link of the link aggregation from which the data packet was sampled.

In the example of multiple distribution switches in a distribution layer to which a point device such as an access layer switch is aggregated in a point-multipoint link aggregation, each distribution switch in general may be programmed to select a physical link directly connected (local) to the access layer device for traffic forwarding “downward” to the access device and not use, for example, an inter-switch link (ISL) between the aggregated distribution layer switches (or another non-direct link) for forwarding to the access layer device (unless the local link(s) to the access switch are down). Beyond the particular example of aggregated distribution switches forwarding to an access layer device, other aggregated devices in point multi-point link aggregations may operate similarly in being programmed to select a physical link directly connected to a point device for downward traffic forwarding. Such a transport of data traffic “downward” from an aggregated switch in a point-multipoint link aggregation to the point device along a direct physical link to the point device may be used to represent an efficient, optimal transport of a data packet from the aggregated device to the point device. Knowledge of that efficient downward transport may be collected at the point device in a point-multipoint link aggregation and used to optimize “upward” traffic forwarding.

For example in the case of an distribution switch of a point-multipoint link aggregation sending data traffic to an access layer point device, such as an access switch, knowledge of that efficient downward transport may be collected at the access layer device and used to optimize upward traffic forwarding. By charting that efficient downward movement for a flow (as represented by data packet movements), the access layer device in this example may become “flow aware” and use the information in a constructed flow table (or link selector data table), when sending packets upward (i.e. from the access switch to the distribution layer), thereby avoiding distribution layer bottlenecks that may occur in point multi-point switching. The charting of the downward movements of the communications flows may be stored in a link selector data table and used for the sending of upward-moving data traffic along the possible links of a point multi-point link aggregation. A point multi-point link aggregation device, such as an access layer device, may use the link selector data table to send data traffic to the distribution layer devices instead of using a hash function or other algorithm to determine the physical link for sending.

To construct a link selector data table in one example, a point device in point multi-point link aggregation scheme, such as an access switch may sample traffic received on the aggregation links connected to multi-point devices, such as the distribution switches in the distribution layer

With records available (built from “downward” sampled data traffic) in a link selector data table, when traffic needs to move (“upward”) from a point device to one of the multi-point devices in a point multi-point link aggregation topology (such as for example where an access switch in an access layer transports a data packet to one of the distribution switches in a distribution layer via a point multi-point link aggregation), the forwarding engine of the point device (e.g. the access switch) may use the link selector data table to identify a physical link from the aggregation corresponding to a communication flow that may be identified for the data packet. If an entry is found in the link selector data table for a communication flow that corresponds to the data packet for sending, the physical link that corresponds to the communication flow may then be chosen as the output link on which to send the data packet. If there is no communication flow entry for a given packet (or if the data packet in question cannot be found to belong to any currently identified communication flow), the forwarding engine of the sending device (e.g. the forwarding engine of the access switch) may fall back to another scheme, such as a known hash scheme (e.g. using a hash algorithm) for link selection.

In maintaining the link selector data table, a point device, such as an access switch, in a point multi-point link aggregation scheme may keep track of current communication flows and remove or age-out entries that are no longer active.

Traffic Forwarding Using Link Selector Data Table

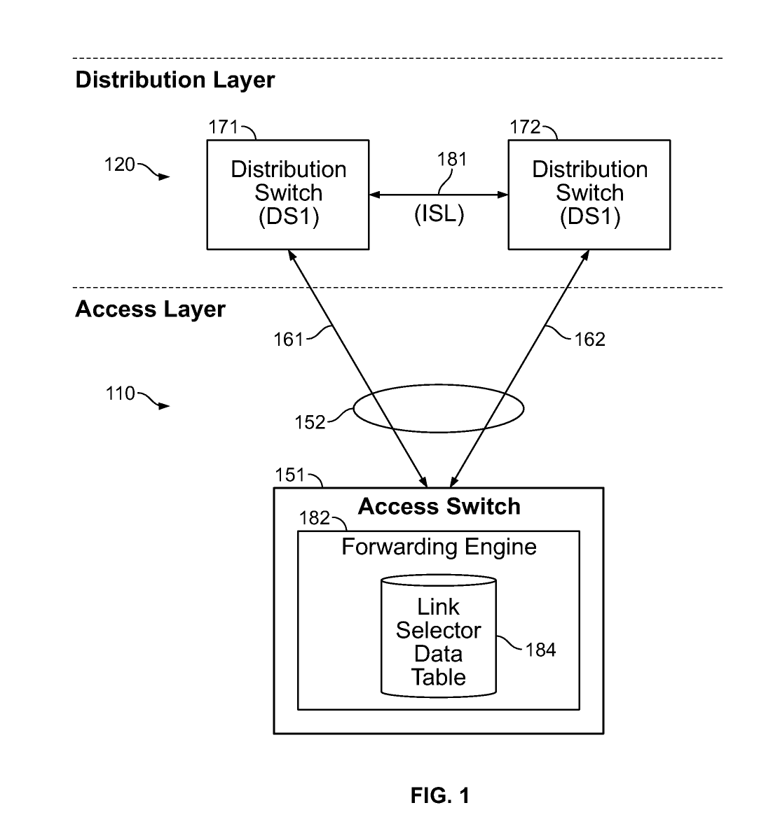

Reference is now made to FIG. 1, which illustrates an example point multi-point link aggregation scheme where the forwarding device performs forwarding to links of the link aggregation using a communication flow-aware link selection scheme based on information stored in a link selector data table. In FIG. 1 the forwarding device is access switch 151. In this example access switch 151 is included in a hierarchical network architecture having access layer 110, distribution layer 120 and core layer (not shown). Access switch 151 may be included in access layer 110. Access switch 151 may be connected by physical links 161, 162 to two different switches 171, 172 of distribution layer 120. Point mufti-point link aggregation schemes may permit links physically terminating on two different switches (e.g. distribution layer switches 171, 172 in FIG. 1) to appear as a single logical link, logical link 152 (link aggregation), to access switch 151. The link aggregated device (e.g. access switch 151 in FIG. 1) may be a switch, server or any other networking infrastructure that supports IEEE 802.1AX (or earlier IEEE 802.3ad) static link aggregation. Through link aggregation, access switch 151 perceives distribution switches 171, 172 as one logical switch (accessible through logical link (link aggregation) 152).

In the point multi-point aggregation scheme as shown in FIG. 1, data packet traffic moving from access switch 151 to distribution layer 120 may be split across the two physical links of the aggregation (161, 162). In systems that may be commercially available, the splitting of data may be performed using a scheme, such as for example, a hashing algorithm that selects one or the other of the physical links 161, 162 for forwarding data packets to one of the distribution switches 171, 172 in distribution layer 120.

While hashing algorithms may balance load between the available physical links, e.g. 161, 162, (and provide connection redundancy and increase communication bandwidth) bottlenecks can occur also when, for example, one switch of the link aggregation (for example distribution switch 172), receives traffic from the link aggregation sender (e.g. access switch 151) that ultimately needs to be delivered to the other switch in the link aggregation (for example distribution switch 171). A bottleneck can form, because the one switch connected to one physical link in the aggregation (e.g. distribution switch 171) has to receive traffic from the sending switch (e.g. access switch 151) and then must immediately forward the same traffic to the other switch (e.g. distribution switch 172) in the aggregation.

Switches, such as distribution switches 171, 172 in a point multi-point link aggregation may be inter-connected by a dedicated inter-switch link (ISL) 181. The ISL 181 may provide a control path for the exchange of link configuration and runtime state information (e.g. to allow sharing of switch forwarding tables, such as tables used for lookup of destination addresses). ISL 181 also may provide a data path that interconnects the two distribution layer switches. When used as a data path, ISL 181 may be used to transfer data packets between the switches.

In a bottleneck situation, a distribution layer switch (e.g. 171) that may receive traffic from an access layer device (e.g. switch 151) may end up forwarding the traffic to its peer distribution switch 172 using the ISL 181. The additional forwarding hop from one distribution switch to the other may be non-optimal and may unnecessarily overload the link interconnecting the distribution switches.

In FIG. 1, access switch 151 may include forwarding engine 182, which may forward data packets using link selector data table 184 for traffic forwarding. The use of link selector data table 184 for traffic forwarding may provide a flow-aware link selection scheme for forwarding traffic from access switch 151 to the receiving devices (e.g. distribution switches 171, 172) in a point multi-point link aggregation.

Each record in link selector data table 184 may include data to identify a communication flow and a physical link that corresponds to the flow. The records of link selector data table 184 may be generated by sampling traffic when data packets are sent “downward”, from distribution switches 171, 172 to access switch 151. When a communication flow is identified for a downward communication along one of the physical links of the link aggregation (e.g. links 161 or 162), the communication flow may be associated with one of the physical links and a record of the communication flow and its associated physical link may be stored in link selector data table 184. When access switch 151 receives a data packet for forwarding “upward” (e.g. to one of the distribution switches 171, 172 in distribution layer 120, rather than from those switches), the records generated from the “downward” samplings may then be used to find the physical link for forwarding the “upward” communications.

By charting efficient “downward” movement for a flow (as represented by the movement of the data packets from the distribution switches to the access layer switch), access layer switch 151 in this example may become “flow aware” and use the information in the constructed flow table, when sending packets “upward” (i.e. from the access switch to the distribution layer), thereby avoiding distribution layer bottlenecks that can occur in point multi-point link aggregations. As stated when a data packet at one of the distribution switches (e.g. 171) needs to move downward, e.g. from the distribution switch to the access layer device (e.g. access switch 151), the distribution switch may select the physical link (e.g. 161) directly connected (local) to access switch 151 (and not, for example use the ISL link 181 or another indirect link) for forwarding the data packet to the layer access device (unless its local link(s) to the access switch are down). Such a transport “downward” from the distribution layer switch to the access layer device, using the direct physical link (e.g. 161) may be used to represent an efficient, optimal transport of a data packet from that distribution switch to access device. Knowledge of that efficient downward transport may be collected at the access layer device and used to optimize upward traffic forwarding.

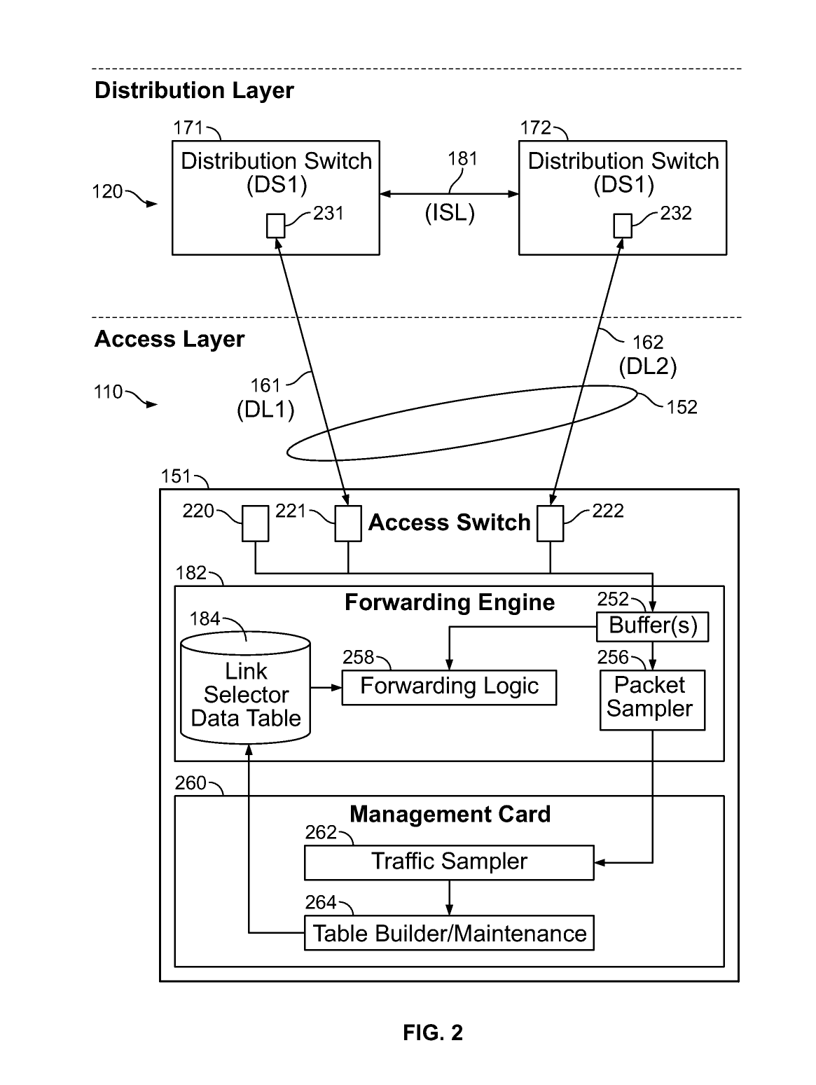

Reference is now made to FIG. 2, which illustrates in block diagram form point multi-point link aggregation using a flow-aware link selection scheme for traffic forwarding. In FIG. 2, as in FIG. 1, the point multi-point link aggregation configuration is that of access switch 151 of access layer 110, which is coupled to distribution switches 171, 172 of distribution layer 120 by link aggregation 152. Access switch 151 may use link aggregation 152 for forwarding data packet traffic to the switches in distribution layer 120. Link aggregation 152 may include physical links 161, 162, which may allow access switch 151 to perform its forwarding of data packet traffic using link aggregation 152. Access switch 151 may include ports 221, 222 to couple physical links 161, 162, respectively, to access switch 151. Ports 221, 222 may allow access switch 151 to forward data packets across physical links 161, 162 to distribution switches 171, 172 of distribution layer 120. Distribution switch 171 may include port 231 to couple physical link 161 to distribution switch 171. Port 231 may allow distribution switch 171 to receive data traffic from access switch 151 across physical link 161. Distribution switch 172 may include port 232 to couple physical link 162 to distribution switch 172. Port 232 may allow distribution switch 172 to receive data traffic from access switch 151 across physical link 162. ISL 181 may also interconnect distribution switches 171 and 172.

Access switch 151 may also include additional ports, such as port 220, which may be coupled to other networking devices, such as servers (not shown). Port 220 may allow access switch to receive in-coming data packets for transport or forwarding to switches in distribution layer 120 (including distribution switches 171, 172 accessed by access switch 151 via link aggregation 152). Distribution switches 171, 172 also may be configured to send data traffic to access switch 151 for forwarding to other devices. The additional ports, such as port 220 may be coupled to servers, for example, which may use access switch 151 to forward data traffic for flows (e.g. data exchange or communication flows) to distribution layer 120 (and from thereon to other destinations in a network).

Access switch 151 may further include processors and processing units to process data packet traffic. Data traffic received at access switch 151, for example received at ports 220, 221, 222, may be transferred within access switch 151 to forwarding engine 182 for processing. Forwarding engine 182 may include a processor (or a number of processors) and processing logic (e.g. in the form of logic circuitry or executable code) to process data packet traffic.

Data traffic received at ports 220, 221, 222 may be transferred to buffer(s) 252 of forwarding engine 182. As stated, to become flow aware (to obtain information concerning communication flows), access switch 151 may build and maintain records in link selector data table 184 that may store information concerning the various flows that may come (downstream) from the distribution switches of distribution layer 120 of point multi-point link aggregation 152 (e.g. from distribution switches 171, 172) and physical links 161, 162 of point multi-point link aggregation 152 that the traffic comes in on.

In one example, link selector data table 184 may be maintained as part of forwarding engine 182. In other examples, link selector data table 184 may be maintained in other locations, for example, which may be accessible by forwarding engine 182.

To build and maintain the records of link selector data table 184, access switch 151 may monitor incoming data traffic and collect information from data packets that arrive from the distribution switches (e.g. switches 171, 172) used in link aggregation 152. For traffic monitoring, forwarding engine 182 may include packet sampler 256, which on a periodic basis may sample incoming data packets stored, for example, in buffer(s) 252. In one example packet sampler 256 may use sFlow (RFC 3176), a known packet sampling technique in which forwarding engine 182 (typically an ASIC or a network processor) may periodically sample packets being forwarded on its links and send the sampled packets to management card 260 for processing. In other examples, other packet sampling techniques may be used, such as for example, NETFLOW (RFC 3954) or IPFIX (RFC 3917). In still other examples, proprietary sampling techniques may be used.

Management card 260 may include a processor (or a number of processors) and processing logic (e.g. in the form of executable code or logic circuitry) to perform, for example, management functions related to the operations of access switch 151. When sampled packet data is sent to management card 260 from packet sampler 256, the sampled packet data may be received by traffic sampler 262, which may perform general packet sampling function such as parsing the sampled frame, ignoring error frames if any, and identifying flow information for a valid sampled frame that may be used by table builder/maintenance unit 264 to build the link selector record. Table builder/maintenance unit 264 may build record for link selector data table 184 and also maintain link selector data table 184, for example deleting (or aging-out records) to maintain a compact and efficient data table for data traffic forwarding.

From every sampled frame of a data packet that packet sampler unit 256 may sample from buffers) 252, traffic sampler 262 may extract flow parameters concerning that frame (e.g. frame may be a term for a data packet within a layer) and pass these parameters to the table builder/maintenance unit 264. Table builder/maintenance unit 264 may identify from those passed parameters a communication flow that corresponds to the sampled frame. For that identified communication flow, table builder/maintenance unit 264 may build a record to store flow parameters that uniquely identify the communication flow and with those flow parameters also store an indication of the physical link that the data packet (frame) was received on.

Table builder/maintenance unit 264 may then store the built record in link selector data table 184 for use by forwarding engine 182 in forwarding data traffic from access switch to the switches of distribution layer 120 that are used by link aggregation 152 (e.g. distribution switches 171, 172). As more data packets are sampled and analyzed, table builder/maintenance unit 264 may create in link selector data table 184 a database that identifies the flows of the data traffic that are coming downstream to access switch 151 and that further identifies the physical links that are used by each flow in that downstream traffic movement. Records may be collected over time and data for the stable communication flows (e.g. flows that have persisted in the samples for a period of time) may be kept or allowed to remain in link selector data table 184.

Table builder/maintenance unit 264 may further keep track of the current communication flows corning downstream and delete (or age-out) from link selector data table 184 entries that are no longer active. By such further maintenance, older (or stale) entries may be removed so, for example, they do not waste space in link selector data table 184. This may allow for a compact database that permits speedy look-ups in operation by forwarding engine 182.

When a data packet is received (e.g. at port 220), which may require forwarding upstream to distribution layer 120 using link aggregation 152, forwarding engine 182, for example using forwarding logic 258, may access link selector data table 184 to determine if the data packet received for forwarding upstream can be identified to a communication flow for which information has been collected in link selector data table 184 based on sampled downstream transmissions.

In such an example, forwarding logic 258 may extract information from received data packet for forwarding upstream and compare the flow parameters found in the data packet received with flow parameters stored in the records of link selector data table 184. If forwarding logic 258 may find an entry in link selector data table 184 for a communication flow that matches the flow parameters extracted from the data packet received, the corresponding physical link (e.g. 161 or 162) that is stored with the record may be selected as the physical link forwarding the data packet received. If forwarding logic 258 does not find an entry in link selector data table 184 for a communication flow that matches the flow parameters for the data packet received, forwarding logic 258 may use as a back-up strategy another link selection scheme, such as a hash algorithm, to determine link selection for transport in link aggregation 152.

As the physical link chosen for forwarding from link selector data table 184 in this example is the same physical link as data traffic for a given flow had previously used for transporting to access switch 151, the received data packet, when forwarded using the same physical link will not need to traverse extra hops at the switches in destination layer 120 before reaching the packet's intended destination. Link aware selection of physical links for forwarding in a link aggregation, as provided in one example, may reduce data traffic load on ISL 181, by, for example, precluding a second forwarding hop that can potentially lead to transit delays. Link aware selection of physical links for forwarding in a link aggregation, as provided in the example, may further provide an optimal path for traffic forwarding upstream (and/or mitigate non-optimal forwarding) from access switch 151 to the distribution switches 171, 172.

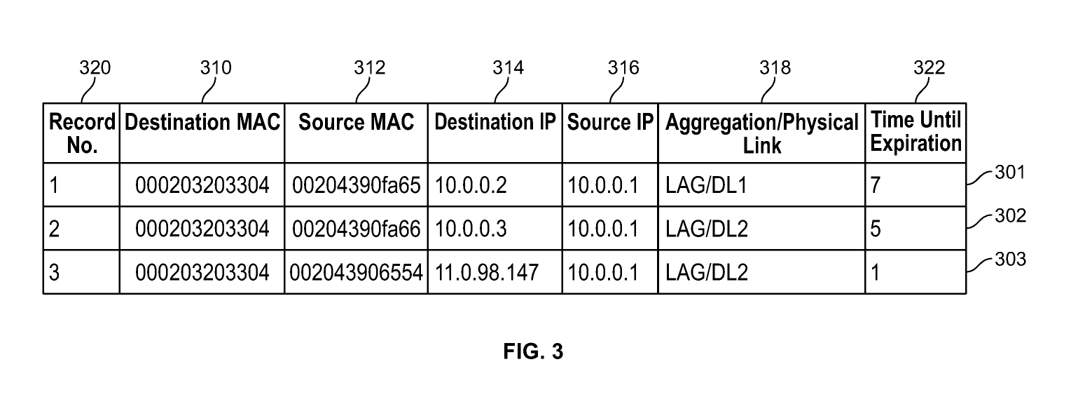

Reference is now made to FIG. 3, which illustrates example record entries from link selector data table 184, FIG. 3 shows records 301, 302, 303, which may, for example have been generated by table builder/maintenance unit 264 and added to link selector data table 184. As stated, a communication flow may be uniquely defined from a set of flow parameters. In such an example, the flow parameters may be data from fields that are contained in a data packet.

For example, when packet sampler 256 samples a data packet, the frame for the data packet may include a number of fields that may be used to uniquely identify a communication flow that corresponds to that sampled frame. The data for such fields may be stored as the flow parameters for the communication flow in records 301, 302, 303. In one example (using ‘IP protocol frames over Ethernet’ format) fields from a data packet frame that may be used identify a communication flow may include fields such as Destination-MAC-Address, Source-MAC-Address, Destination-IP-Address, Source-IP-Address, Source-Port and Destination-Port. In other examples, other fields may be used. In different examples also, one field may be used to identify a communication flow that corresponds to a data packet. In other examples, a number of fields may be used to uniquely identify a communication flow.

In FIG. 3 the fields of Destination-MAC-Address, Source-MAC-Address, Destination-IP-Address, and Source-IP-Address have been used to uniquely identify communication flows. Accordingly, in this example, each record 301, 302, 303 contains flow parameter entries corresponding to a Destination-MAC-Address (see column 310), Source-MAC-Address (see column 312), Destination-IP-Address (see column 314) and Source-IP-Address (see column 316). Each record may also have a field, for example, to identify the record number in the data table (for example see column 320).

In addition to the flow parameter entries (shown by columns 310-316) that uniquely identify a communication flow for each record 301, 302, 303, each record may include an entry to identify a physical link (e.g. 161 or 162 of link aggregation 152), which may be used for forwarding data packets that have flow parameter entry fields that match those of the stored records. The physical links that correspond to the communication flows identified in records 301, 302, 303 are shown in column 318. Data packets received for forwarding may now be matched to a physical link for forwarding based on the flow parameters stored in records 301, 302, 303.

For example, for a received data packet for forwarding that contains values such as: Destination-MAC-Address: 000203203304, Source-MAC-Address: 00204390fa65, Destination-IP-Address: 10.0.0.2 and Source-IP-Address: 10.0.0.1, that data packet may have a corresponding communication flow that matches the flow parameters in record 301. Accordingly, the received data packet may be forwarded to destination layer 120, using the physical link that is identified in record 301 (see “LAG/DL1” identified for record 301 in column 318). That physical link in record 301 is DL1, which in FIG. 2 is shown to correspond to physical link 161). In this manner forwarding logic 258 may use the record of link selector data table 184 (such as records 301, 302, 303) for forwarding received data traffic to distribution layer 120.

In addition to the information stored in records 301, 302, 303 mentioned above, each record 301, 302, 303 may include, for purposes of data table maintenance, a field (as shown in column 322) containing data showing when the record may expire (or grow stale). The information stored for record expiration may have many different forms, which may include a time value or time code.

In column 322 of FIG. 3, each record may hold a numeric value showing the number of time periods that remain for the record before the record may be considered expired (or stale). Records 301, 302, 303 in link selector data table 184, in this example, may be checked on a periodic basis. Each time the records are checked the data in their “time until expiration” field may be decremented until the value, for example, reaches zero. Record 302, for example may be checked five more times, for example, before that record will expire. Record 303 may expire after just one more check period.

When data packets are sampled, however, a new data packet from the same communication flow (but moving downstream, e.g. from distribution layer to access layer) may be used to re-fresh or reset the expiration period for the record. Looking at record 303 as one example, if a new sampled data packet (in-coming to the access device from the distribution layer) is found to have the flow parameter fields of Destination-MAC-Address: 002043906554, Source-MAC-Address: 000203203304, Destination-IP-Address: 10.0.0.1, Source-IP-Address: 11.0.98.147, (and the sampled packet was received at access switch 151 on link 162 (which corresponds to aggregation link DL2), then that sampled packet can be used to re-fresh record 303 and its Time Until Expiration field may be reset.

Notice that in this example the Destination-MAC-Address information of the in-coming data packet is matched against the Source-MAC-Address information stored in record 303 (Destination information for an incoming packet may be matched against source information stored for out-going packets). Likewise, the Source-MAC-Address of the in-coming data packet may be matched against the Destination-MAC-Address of record 303, the Destination-IP-Address of the in-coming data packet may be matched against the Source-IP-Address of record 303, and the Source-IP-Address of the in-coming data packet may be matched against the Destination-IP-Address of record 303. The period for expiration may be determined on factors such as the traffic sampling frequency configured on the management card (which could sample, for example, one in every 50 packets on the wire, e.g. coming to buffer(s) 352) and the rate at which traffic is actually flowing on the wire (which may include statistical data on the chatty nature of each communication flow).

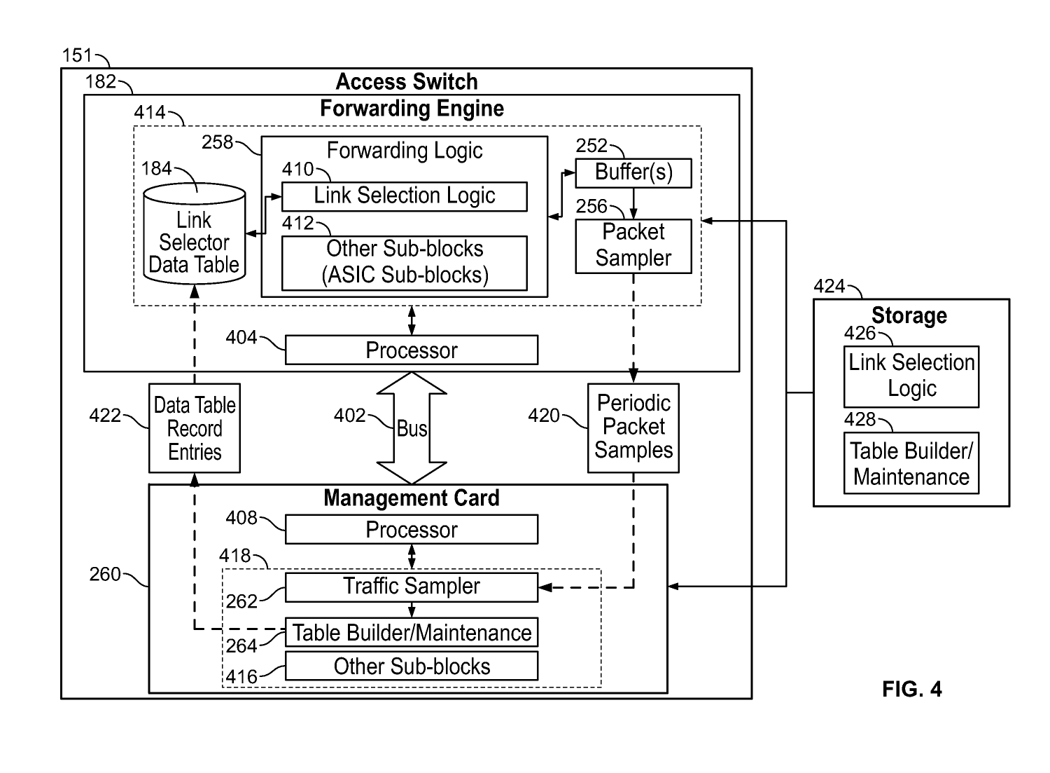

Reference is now made to FIG. 4, which illustrates elements of a flow-aware link selection system, in one example, using again the example of access switch 151. FIG. 4 shows forwarding engine 182 and management card 260 from FIG. 2. In FIG. 4, bus 402 connects forwarding engine 182 and management card 260 and may allow processors 404, 408, respectively, on those components 182, 260 to communicate.

Forwarding engine 182 may include link selector data table 184, forwarding logic 258, packet sampler 256, and buffer(s) 252 (as is also shown in FIG. 2). Data packets may be received from the ports of access switch 151 for processing by forwarding engine 182 at buffer(s) 252. Packet sampler 256 may sample frames from the received data packets.

For example, forwarding engine 182 may include packet sampler 256, where processor 404 executing the procedures of packet sampler 256 may obtain the sample and then forward the sample to management card 260.

Forwarding logic 258 may determine forwarding links for received data packets to be forwarded on link aggregation 152 (not shown in FIG. 4) using link selector data table 184. In selecting physical links in link aggregation 152 for forwarding, in one example, forwarding logic 258 may include link selection logic 410. Forwarding logic 258 may also include other sub-blocks 412, such as ASIC sub-blocks, including Destination-MAC-Address and IP Address lookup table functions, which may be used to determine an egress interface (interface needed for forwarding) a given data packet, an access control list (ACL) sub-block function, which may be used to perform security-related actions on the data packet (e.g. dropping/allowing traffic from or to a host), egress buffers to enqueue packets that need to be sent out by a port, etc.

In one example, forwarding logic 258 (including link selection logic 410 and other sub-blocks 412) and packet sampler 256 may be software elements, elements of executable computer program code, executed by processor 404 of forwarding engine 182. Memory 414 (e.g. processor memory, such as RAM memory), in this example, may include forwarding logic 258 (including link selection logic 410 and other sub-blocks 412) and packet sampler 256.

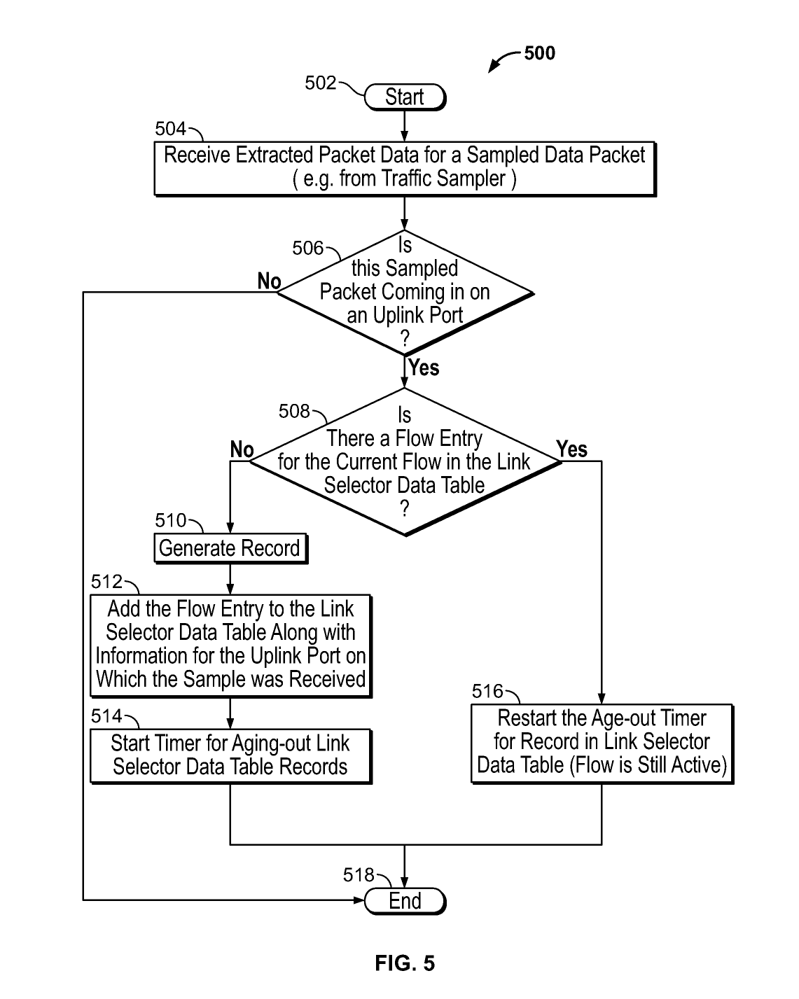

Each of forwarding logic 258 (including link selection logic 410 and other sub-blocks 412) and packet sampler 256 when executed by processor 404, may perform processes described herein, such as obtaining samples of data packets arriving at access switch 151 (e.g. as stored in buffer(s) 252) and determining forwarding links for received data packets to be forwarded on link aggregation 152 (not shown in FIG. 5) using link selector data table 184. Memory 414 may also include link selector data table 184 and buffer(s) 252, which may also be accessible for data storage and retrieval by processor 404 in executing the processes of forwarding logic 258 (including link selection logic 410 and other sub-blocks 412) and packet sampler 256.

In one example, processor 404 may be a computer processor, configured for data traffic forwarding operations in a network device such as access switch 151. In other examples processor 404 may be a general-purpose PC processor or other more specialized processor. Processor 404 may be a single processor or processor 404 may incorporate a number of processors and be capable of distributed processing and/or parallel processing.

Although forwarding logic 258 (including link selection logic 410 and other sub-blocks 412) and packet sampler 256, in one example, may be software elements, in another example, one or more of the elements 258, 410, 412 and/or 256 may be implemented in circuitry as computer hardware elements.

In addition, management card 260 may include traffic sampler 262 and table builder/maintenance unit 264 (as is also shown in FIG. 2). Periodic packet samples 420 (e.g. of frames from received data packets) may be forwarded from packet sampler 256 to traffic sampler 262 (as shown by the dashed arrows from packet sampler 256 to traffic sampler 262). Traffic sampler 262 may extract data from the sampled packet, such as field data like Destination-MAC-Address, Source-MAC-Address, Destination-IP-Address, Source-IP-Address, Destination-Port and Source-Port. Other information, including other fields may also be extracted by traffic sampler 262 from the packet sample 420. Table builder/maintenance unit 264 may receive on a periodic basis extracted field data from traffic sampler 262 and generate data table record entries 422, which may be stored in link selector data table 184 (as shown by the dashed arrows from table builder/maintenance unit 264 to link selector data table 184)

Management card 260, including processor 408, for example, may execute procedures of table builder/maintenance unit 264 to receive extracted field data from a sample of a data packet received at the device (e.g. access switch 151), to determine whether the sample was received in an in-coming transmission to the device along one of the physical links and to store a record including the extracted data and an identifier of the physical link from which the sampled data packet was received in link selector data table 184.

Management card 260 may also include (in addition to traffic sampler 262 and table builder/maintenance unit 264 other sub-blocks 416, such as a protocol stack sub-block for control and management plane traffic processing, a management application server sub-block (e.g. for Telnet protocol or dynamic host configuration protocol (DHCP) applications) and other sub-block processes.

In one example, traffic sampler 262, table builder/maintenance unit 264 and other sub-blocks 416 may be software elements, (elements of executable computer program code) executed by processor 408 of management card 260. In such an example, memory 418, which may be processor memory, such as RAM memory, may include traffic sampler 262, table builder/maintenance unit 264 and other sub-blocks 416.

Each of traffic sampler 262, table builder/maintenance unit 264 and other sub-blocks 416, when executed by processor 408, may perform processes described herein, such as obtaining samples of data packets, generating data table record entries for link selector data table 184, and maintaining the records in link selector data table 184, such as by deleting (or aging-out) records when they are no longer viable for determining physical links for forwarding in link aggregation 152. Memory 414 may also include periodic packet samples 420 as they are received and data table record entries 422 as they are generated.

In one example, processor 408 may be a general PC processor, configured for execution of traffic sampler 262, table builder/maintenance unit 264 and other sub-blocks 416 elements to perform the functions of device management in a network device such as access switch 151. In other examples processor 404 may be a more specialized processor configured specifically for network device management. Processor 408 may be a single processor or processor 408 may incorporate a number of processors and be capable of distributed processing and/or parallel processing.

Although traffic sampler 262, table builder/maintenance unit 264 and other sub-blocks 416, in one example, may be software elements, in another example, one or more of the elements 262, 264 and/or 416 may be implemented in circuitry as computer hardware elements.

Elements such as link selection logic 410 and table builder/maintenance unit 264 may have also been downloaded from storage 424. FIG. 4 shows link selection logic copy 426 and table builder/maintenance unit copy 428 both stored on storage 424.

Link selection logic copy 426 and table builder/maintenance unit copy 428 maintained on storage 424 may be downloaded and installed into memories 414 and 418, such that when installed memory 414 may include link selection logic 410 and memory 418 may contain table builder/maintenance unit 264, corresponding to link selection logic copy 426 and table builder/maintenance unit copy 428, respectively. Storage 424 may be a storage device, which may include disk or server storage, portable memory such as compact disk (CD) memory and/or DVD memory and system memory, such as a hard drive or solid state drive (SSD) on which modules 426, 428 may be installed. Embodiments of the invention may include an article such as a computer or processor readable non-transitory storage medium, such as for example a memory, a disk drive, or a USB flash memory device encoding, including or storing instructions, e.g., computer-executable instructions, which when executed by a processor or controller, cause the processor or controller to carry out methods disclosed herein.

Process Flows

Reference is now made to FIG. 5, which illustrates an exemplary process 500 for building a link selector data table (or flow table) in one example. Process 500, for example may be included in table builder/maintenance unit 264, executed by processor 408 (see FIG. 4). Table builder/maintenance unit 264 may also be executed in computer hardware (as circuitry), and in such an example, process element 500 may be executed by the circuitry of table builder/maintenance unit 264.

Process 500 may receive extracted field data from a sampled data packet received at the device (e.g. access switch 151), and if the sample was received in a transmission in-coming to the device along one of physical links 161, 162 of link aggregation 152 (the extracted data uniquely identifying a flow for the data packet of the sample), process 500 may generate a record comprising the extracted data and an identifier of the physical link from which the data packet of the sample was received at the device and store the record in the link selector data table. Extracting data from one or more fields of the sample may be performed by traffic sampler 262, e.g. executed by processor 408 and that extracted data may be forwarded to table builder/maintenance unit 264. In other examples, data extraction may be performed by table builder/maintenance unit 264.

In FIG. 5, process 500 may be triggered at step 502, and, in step 504, process 500, executing the process of table builder/maintenance unit 264 may receive from traffic sampler 262 extracted packet data from a data packet sampled by packet sampler 256. As stated, packet sampler 256 of forwarding engine 182 the may use sFlow (RFC 3176), a known packet sampling technique in which packet sampler 256, may periodically sample data packets being forwarded on each of the forwarding engine 250's links and send the sampled packets to management card 260 (e.g. to traffic sampler 262) for processing. Though sFlow is used in this example, other packet samplers such as NETFLOW or IPFIX may also be used.

The traffic sampler 262 may extract data from the sampled packets (e.g. extracting field such as Destination-MAC-Address, Source-MAC-Address, Destination-IP-Address, Source-IP-Address, Destination-Port and Source-Port) and pass the extracted packet data to table builder/maintenance unit 264, which may be a software element (or circuitry) configured to perform the function of process 500 (e.g. through its execution by processor 408). In step 506, process 500 may determine whether the received packet data is from a sampled packet that has arrived at access switch 151 from an uplink port (for example, determining if the sampled packet arrived at the access device from a distribution layer switch (e.g. 171, 172, FIGS. 1-2)). Sampled data packets from the distribution layer switches in link aggregation 152 may be used by an access device to build records in link selector data table 184.

If in step 506, process 500 determines that the sampled packet in question is not in-coming from an uplink port, process 500 may terminate, moving to step 518, where in this case process 500 ends and waits then to be re-triggered when new sampled packet data arrives at step 504. If in step 506, process 500 determines that the sampled packet data does come from a data packet sampled from an uplink port, process 500 may then continue to steps 508-516.

As stated, a communication flow may be defined by a set of fields in a data packet that can be used to uniquely identify the communication flow. In this example, process 500 may extract fields from the received packet data, such as Destination-MAC-Address, Source-MAC-Address, Destination-IP-Address, Source-IP-Address, Source-Port and Destination-Port, and these fields may be used to identify the flow. In the example shown in FIG. 3, the fields of Destination-MAC-Address, Source-MAC-Address, Destination-IP-Address, and Source-IP-Address are shown to uniquely identify the flow. A minimum of fields may be Destination-MAC-Address and/or Destination-IP-Address, but Destination-MAC-Address, Source-MAC-Address, Destination-IP-Address, and Source-IP-Address are used in this example as one type of average use case. In other examples, other fields such as Source-Port and Destination-Port may be used, e.g. in combinations with other fields, to uniquely identify the communication flow.

In step 508, process 500 may use the extracted flow information from the sampled packet to determine if there is a record in link selector data table 184 having flow parameters that correspond to the communication flow identified by the information extracted from the packet data sample. Process 500 may match the entries of the sample for the fields of Destination-MAC-Address, Source-MAC-Address, Destination-IP-Address, Source-IP-Address, for example, against entries stored for such fields stored in link selector data table 184. For matching the extracted field data of the data packet sample against fields in records of the link selector data table 184, process 500 in step 508 may attempt to match, for example:
The Destination-MAC-Address of the packet data sample against the Source-MAC-Address stored in the record;
The Source-MAC-Address of the packet data sample against the Destination-MAC-Address stored in the record;
The Destination-IP-Address of the packet data sample against the Source-IP-Address stored in the record; and
The Source-IP-Address of the packet data sample against the Destination-IP-Address stored in the record.

In other examples, other fields may be stored in records to uniquely identify a communication flow and those fields may be matched against corresponding parameters in the data packet sample in step 510.

If there is no match in step 508 (such that the flow information extracted from the sampled packet data does not match an entry in a record in link selector data table 184, process 500 proceeds in step 510 to generate a flow record and then in step 512 may add the new record to link selector data table 184 (to build the table of flow records).

For example, process 500 may generate (in step 510) and store (in step 512) a record when link selector data table 184 does not contain a record for the communication flow that is identified by the extracted data of the sample. For this newly-identified communication flow, process 500 may generate a new record containing the extracted flow information (the fields that uniquely identify the new flow) and also add to this record an indication of the uplink port (the aggregation link) on which the sampled packet arrived at access switch 151. For example, process 500 may in step 512 store:
The Destination-MAC-Address of the packet data sample as the Source-MAC-Address in the new record;
The Source-MAC-Address of the packet data sample as the Destination-MAC-Address in the new record;
The Destination-IP-Address of the packet data sample as the Source-IP-Address in the new record; and
The Source-IP-Address of the packet data sample as the Destination-IP-Address stored in the new record.

In step 514, process 500 may then start a timer (for purposes of aging-out the new record after a predetermined period (e.g. a period based on the traffic sampling frequency of the management card or the rate at which traffic is actually flowing through the link aggregation). The aging-out process may keep records for the most current flows in link selector flow table 184, and may allow the link selector flow table to purge older records for communication flows that have terminated.

If in step 508, process 500 determines that there is already a record in link selector data table 184 having information that matches the extracted parameters of the data packet sample (e.g. the flow information extracted from the sampled packet matches that of an existing record in link selector data table 184), process 500 may then proceed to step 516, where process 500 may restart, or otherwise update, the age-out timer for the corresponding record in the link selector database (e.g. see column 322, FIG. 3). As stated each record in link selector data table 184 may have been generated with a value to indicate an expiration of the record (see step 514, FIG. 5 and column 322, FIG. 3). In step 516, process 500 may update an age-out timer (or age counter value) in one of the records in link selector data table 184, if the record whose age counter value is updated identifies a communication flow that matches the extracted data of the sample.

The age-out timer (or age counter value), for example, provides a number of timing periods that a flow record may exist in link selector data table 184, before being removed. When a flow is active, its age out timer may be refreshed (or updated) each time a new packet arrives from the distribution layer along the same link in the aggregation (the same uplink port in the aggregation).

With either a new record created (in steps 510-514) or the age-out timer (age counter value) updated (in step 516) for an existing record in link selector data table 184, the process terminates in step 518.

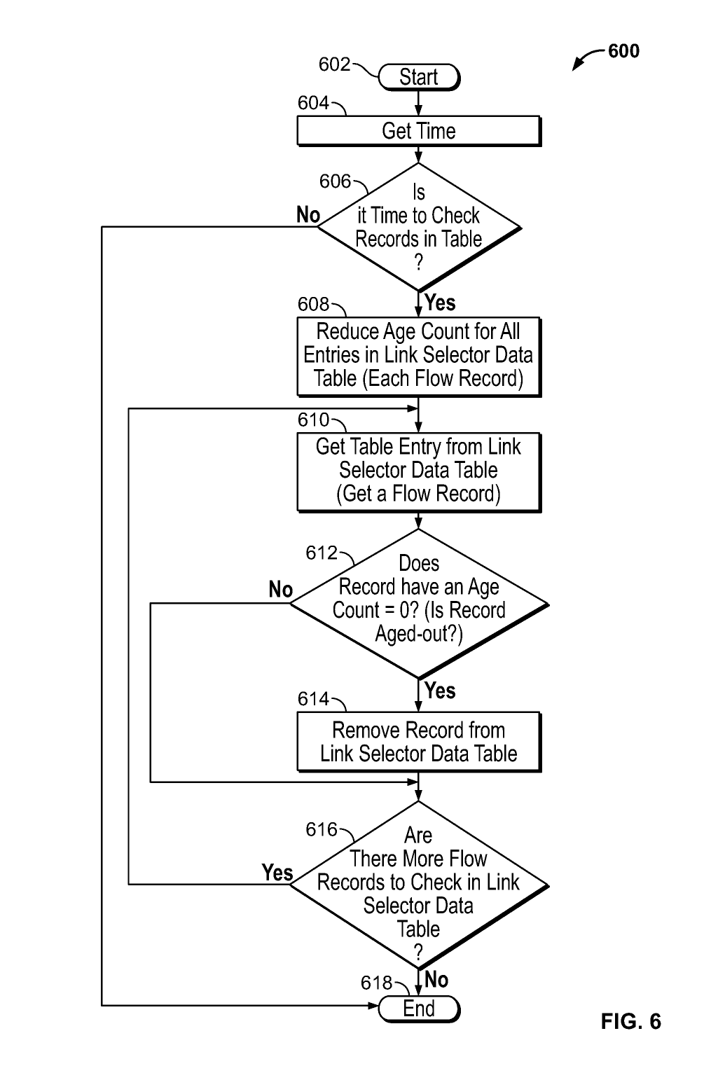

Reference is now made to FIG. 6, which illustrates example process 600 for aging-out entries in link selector data table 184, in one example. Process 600, for example may be included in table builder/maintenance unit 264, for example executed by processor 408 (see FIG. 4). Table builder/maintenance unit 264 may also be executed in computer hardware (as circuitry), and in such an example, process 600 may be executed by the circuitry of table builder/maintenance element 264. Process 600 may be configured for example to decrement an age count value in each of the records of link selector data table 184 and delete a record from link selector data table 184, upon determining that the age count value of the record is equal to a pre-determined minimum floor value.

In FIG. 6, the process may begin at step 602 and in step 604, process 600 may get the current time, which may be provided example by a system clock associated with processor 408 of management card 260. (See FIG. 4). In step 606, process 600 checks to determine if it is time to check the records in link selector data table 184. Process 600 may check records on a periodic basis, such as every 10 seconds or upon a user configured timeout cycle. If in step 606, it is not time to check the records, process may terminate moving to step 618, where process 600 may be triggered again at the next time check. If in step 606, process 600 determines that it is time to check the records in link selector data table 184, process 600 proceeds to step 608 to reduce an age count value for all of the flow table entries (all the flow table records) in link selector data table 184.

As shown in FIG. 3 (see column 322), each record in link selector data table 184 may include an age-out (or age count) value, such as for example a number between 1 and 10 or some other value indicating the age of the record. For each period the records are checked, process 600 may, for example decrement the age-out value (see column 322, FIG. 3) for each record. When the age-out (age count) value in a record becomes zero (or another predetermined floor value), the record may be deleted from link selector data table 184.

In steps 610-616, process 600 may then check each record and remove each record that should be aged-out (or those records where the flow has not been active at access switch 151 for some time).

In step 610, process 600 gets a table entry (a flow record) from link selector data table 184. In step 612, process 600 may check the age-out (age count) value of the record. If in step 612 the record has a value that is not zero (in this example a positive value), the record may not need to be removed. In such a case, process 600 may proceed to step 616. If, however, process 600 determines in step 612, that the record in question has a value that is zero, process 600 may proceed in step 614 to delete the record. The record in question has been aged out, making room for records concerning more recent, more active flows.

In step 616, process 600 determines if there are more records in link selector data table 184 to check for determining whether or not those records should be aged-out. If there are more records, process 600 returns to step 610 and repeats steps 610-616 for each additional record. If there are no more records to check in link selector data table 184, process 600 terminates at step 618.

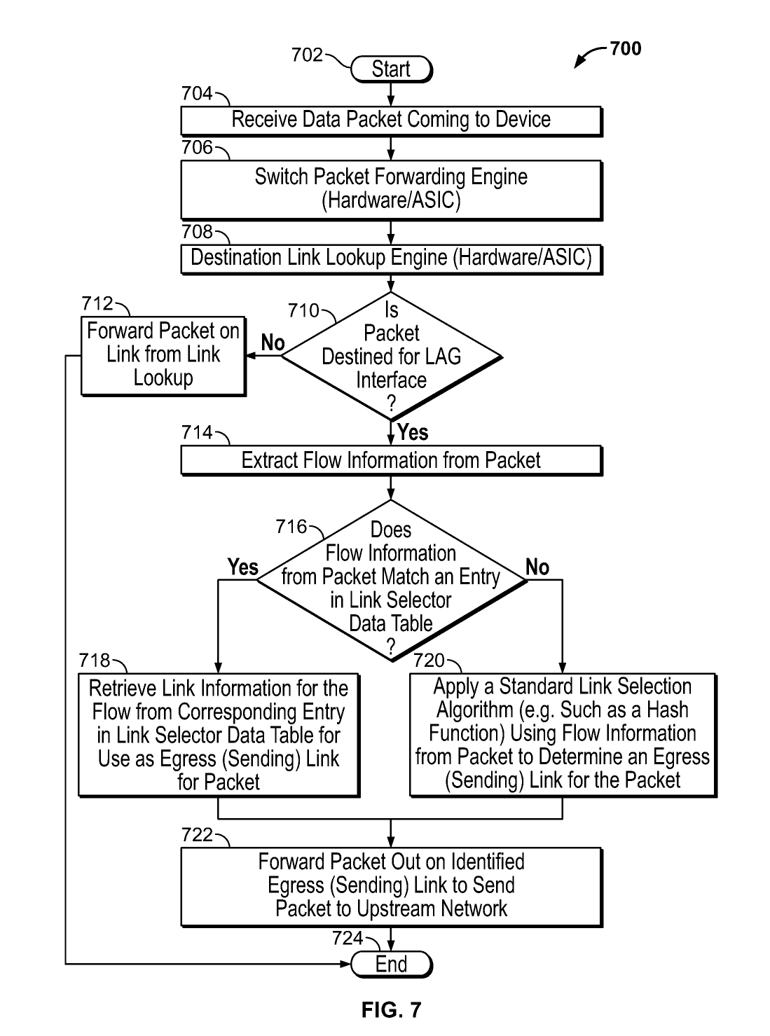

Reference is now made to FIG. 7, which illustrates an example process 700 for link selection. Process 700, for example, may be executed by processor 404 when executing forwarding logic 258 of forwarding engine 182. Forwarding logic 258 may include link selection logic 410, which may perform physical link selection for link aggregation 152, using link selector data table 184. In one example, forwarding logic 258 (including link selection logic 410) may be an element of forwarding engine 182 that may be implemented software. In another example, forwarding logic 258 (including link selection logic 410) may be implemented in computer hardware (as circuitry), where process 700 may be executed by the circuitry of forwarding logic 258 that includes link selection logic 410.

In FIG. 7, process 700 may be triggered at step 702, and, in step 704, process 700 may receive a data packet at access switch 151. The data packet may be received at a port, such as port 220 in FIG. 2. In step 706, a processor monitoring port 220 may forward the data packet to forwarding engine 182.

In step 708, process 700 may execute a destination link lookup (e.g. using a destination link lookup engine, which may be known or commonly performed in forwarding). Such a process may be performed by forwarding logic 258 and may include:
Packet parsing and validation—where a sub-unit may parse the various fields in the packet and validate that the packet has the right checksum, confirm that there are no MTU exceeded errors, that the packet is coming in on the right VLAN, etc;
Source address lookup and learn—where a sub-unit may populate a forwarding table in access switch 151 with information on the switch port each destination address may be connected to;
Destination lookup (or Destination Link)—where a sub-unit may take the destination address fields like the MAC and IP, and use this information to look up in the forwarding table to decide which switch port to send the data packet out of; and
Other processes—such as an access control list (ACL) process to, perform security-related actions on the data packet (e.g. dropping/allowing traffic from or to a host), egress buffers per port to enqueue packets that need to be sent out by a port, etc.

In step 710, process 700 may determine from the destination established in step 708, whether or not the data packet is to be sent out on the link aggregation interface (whether or not the data packet will be forwarded on link aggregation 152).

If in step 710 the data packet is not destined for transmission (forwarding) via the link aggregation interface, in step 712, process 700 may forward the data packet, using the destination link information determined in step 708 (e.g. using a packet forwarding unit (not shown)).

If in step 710, the data packet is destined for transmission via link aggregation 152, process 700, for example now executing the link selection logic 410, may proceed to step 714 and extract flow information from the data packet. For example, process 700 may extract fields from the data packet, such as Source-MAC-Address, Source-IP-Address, Destination-MAC-Address, Destination-IP-Address, Protocol (or other field information, e.g. Source-Port, Destination-Port) to uniquely identify the communication flow to which the data packet in question belongs.

In step 716, process 700 may determine if the flow information extracted from the data packet matches a record for a communication flow in link selector data table 184. If in step 716 the extracted flow information does match a record for a flow in link selector data table 184, process 700 may, in step 718, select as the physical link for transmitting the data packet, the physical link that is identified in the flow record. In step 722 process 700 may use this identified physical link to transmit the data packet to the corresponding distribution switch in distribution layer 120. As stated above, when creating a flow record a physical link that corresponds to the communication flow may be stored with the flow information for each communication flow identified from distribution-layer-switch to access-layer-switch traffic. That same physical link may now be used as the physical link for forwarding (sending a data packet for the same flow from the access layer to the distribution layer).

If in step 716, process 700 finds no record in link selector data table 184 that corresponds to the extracted flow information for the data packet, process 700 may proceed to step 720, where it may apply a standard link selection algorithm (such as a hash function) to determine a physical link for sending the data packet in the link aggregation. In step 722, process 700 may send the data packet to a switch in the distribution layer using this link. As stated, the conventional link selection scheme of, for example, a hash function, may be used as a fallback scheme to transport packet traffic when there is no entry for a given flow in link selector data table 184. Using such a configuration where a conventional link selection scheme is used as a fall back, there may be no loss of traffic or connectivity in the time, for example, when link selector data table entries are being learned or when there is a churn in the distribution layer.

With the data packet transmitted in step 722 on a physical link (found in either step 718 or 720), the process terminates in step 724.

Forwarding Scenarios

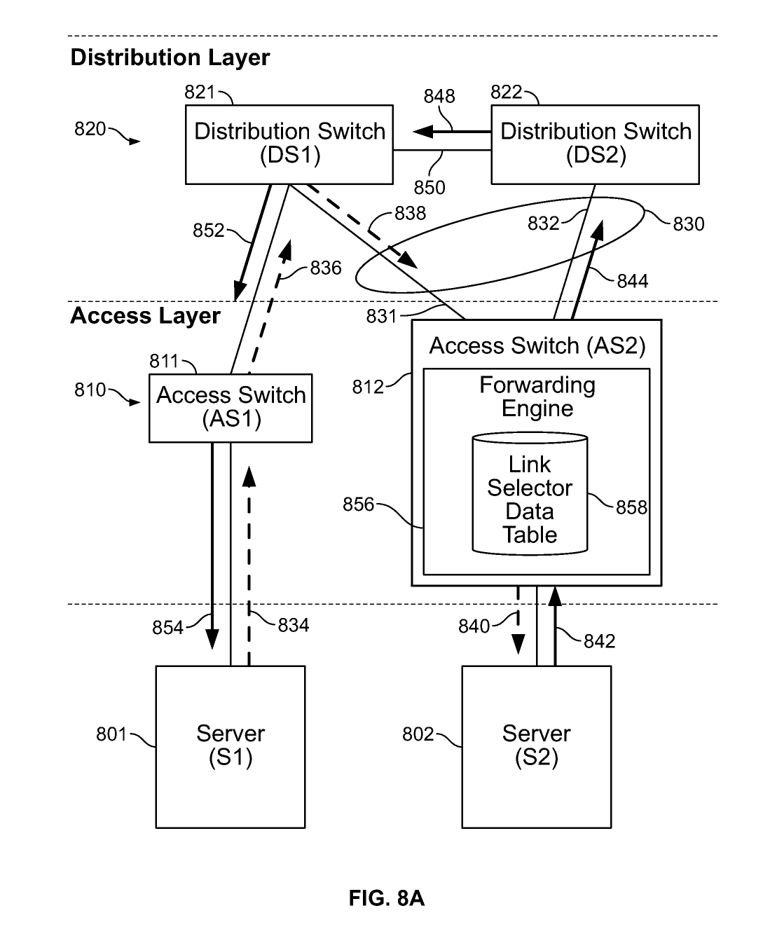

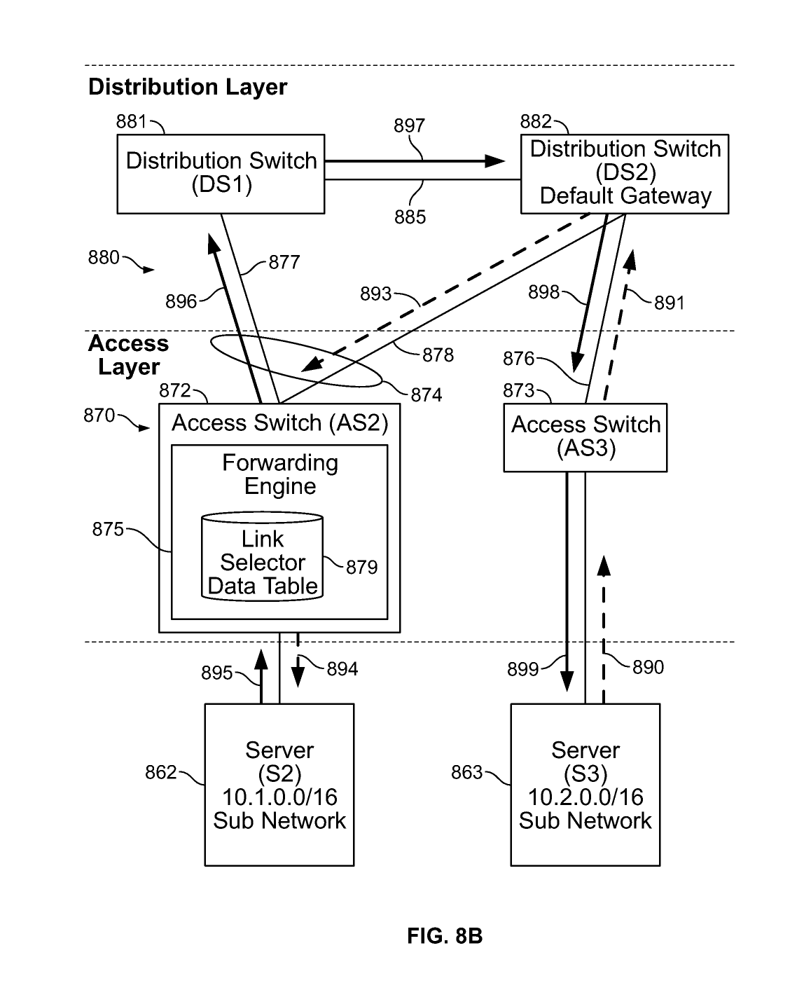

To provide further understanding of possible uses of a point multi-point link aggregation using flow-aware forwarding with a link selector data table, two scenarios are presented in FIGS. 8A-8B.

Reference is now made to FIG. 8A, which illustrates communication between server 801 (S1) and server 802 (S2) residing on the same LAN (local area network. Server 801 (S1) and server 802 (S2) communicate via access switches 811, 812 in access layer 810 and distribution switches 821, 822 in distribution layer 820. In this example, server 801 (S1) is connected to distribution switch 821 (DS1) via the access switch 811 (AS1). Server 802 (S2) is connected to the access layer switch 812 (AS2), where access layer switch 812 (AS2) is linked to distribution switches 821 and 822 in point multi-point link aggregation 830 (which includes physical links 831 and 832). Access switch 812 may include forwarding engine 856 configured with link selector data table 858 for flow aware forwarding at access switch 812.

When server 801 (S1) transmits a communication to server 802 (S2), data packet traffic for this communication flow (represented at this instance by dashed arrow 834) moves from server 801 (S1) to access switch 811 (AS1). From access switch 811 (AS1), the data packet traffic (now represented by dashed arrow 836) moves upstream to distribution switch 821 (DS1). Distribution switch 821 (DS1) then forwards the data packet traffic (represented at this instance by dashed arrow 838) downstream to access switch 812 (AS2). From access switch 812 (AS2) the data packet traffic may be then forwarded (as represented by dashed arrow 840) to server 802 (S2).

However, at access switch 812, the data packet coming “downstream” to access switch 812 (e.g. in transfer 838) may be sampled, and access switch 812 may create a record in link selector data table 858 indicating that for this communication flow, the physical link for upward communication at access switch 812 should be physical link 831.

When server 802 (S2) replies back to server 801 (S1), data packet traffic for the communication flow (represented in this instance by solid arrow 842) may first travel to access switch 812 (AS2). At access switch 812 (AS2), the data packet traffic may be forwarded upstream to one of distribution switches 821, 822 in distribution layer 820, via either physical link 831 or link 832 of point multi-point link aggregation 830.

Where forwarding engine 856 of access switch 812 is not using a link selector data table (e.g. 858) for making link selections, forwarding engine 856 might use a link selection algorithm, such as a hashing algorithm, configured for the aggregation. Such a hashing algorithm might, for example, hash on the Destination-MAC-Address and Source-MAC-Address address fields or Destination-IP-Address and Source-IP-Address fields may be computed to select which physical link (e.g. 831, 832) to use in forwarding data packet traffic.

Using such a hashing scheme, one non-optimal result may occur where the hashing results in physical link 832 being chosen. If physical link 832 was selected, the reply traffic (represented in this instance by solid arrow 844) may move to distribution switch 822 (DS2). Distribution switch 822 (DS2), in turn, may perform a lookup on the frame within the data packet and may determine that server 801 (S1) is reachable via distribution switch 821 (DS1). Distribution switch 822 (DS2) may then forward the reply traffic (represented in this instance by arrow 848) to distribution switch 821 (DS1) over ISL 850. The reply traffic, as shown by solid arrows 852, 854, may then travel to server 801 (S1).

In this example, the hash scheme been performed by access switch 812 (AS2) resulted in physical link 831 being selected and that selection created an extra forwarding hop from distribution switch 822 (DS2) to distribution switch 821 (DS1) over ISL 850. This extra forwarding hop in the path of traffic from server 802 (S2) to Server 801 (S1) can overburden ISL 850 and add to unnecessary in flight (transmission) delays.

In this example, using information from link selector data table 858, the extra hop may be avoided. When the transmission of data arrives at access switch 812 (e.g. in movement 842) for transport to distribution layer 820, forwarding engine 856 may match the fields of the received data packet against fields in the records of link selector data table 858. As the communication flow corresponding to the data packet had been sampled (and a record for the communication flow created in link selector data table 858), the record for the communication flow may indicate that physical link 831 should be chosen for the upstream transport. By choosing physical link 831 rather than physical link 832 in link aggregation 830, the extra transport hop (e.g. 848) may be avoided.

Another scenario where forwarding over a point multi-point link aggregation may be seen when the switches at a distribution layer are configured as Layer 3 (inter-network) gateways. In an open systems interconnection (OSI) model of computer networking, Layer 3 or the third layer of the seven-layered OSI model may be the network layer (the seven layers are 1. physical layer, 2. data link layer, 3. network layer, 4. transport layer, 5. session layer, 6. presentation layer and 7. application layer). A network layer may provide functional and procedural structures for transferring data from a source to a destination host via one or more networks.

Reference now is made to FIG. 8B, which illustrates movement of packet traffic, from forwarding engine with a link selector data table, where the distribution layers switches are configured as Layer 3 gateways.

In the example of FIG. 8B, server 862 (S2) resides on sub-network 10.1.0.0/16 and server 863 (S3) resides on sub-network 10.2.0.0/16. Both servers 862, 863 are configured with distribution switch 882 (DS2) as their default gateway. Server 863 (S3) may be connected to distribution switch 882 (DS2), the default gateway, via the access switch 873 (AS3). Server 862 (S2) may be connected to the access layer switch 872 (AS2), where access layer switch 872 (AS2) may be linked to distribution switches 881 and 882 in point multi-point link aggregation 874 (which includes physical links 877 and 878). Access switch 872 may include forwarding engine 875 configured with link selector data table 879 for flow aware forwarding at access switch 872.

When server 863 (S3) wishes to communicate with server 862 (S2), server 863 (S3) sends packet traffic (represented at this instance by dashed arrow 890) to access switch 873 of access layer 870. Access switch 873, in turn may forward the packet traffic (as represented by dashed arrow 891) to the default gateway 882 (DS2) in distribution layer 880, which may route the data packet traffic (represented in this instance by dashed arrow 893) to access switch 872 (AS2) of access layer 870.

At access switch 879, the data packet coming “downstream” (e.g. in transfer 893) may be sampled, and access switch 872 may create a record in link selector data table 879 indicating that for this communication flow, the physical link for upward communication at access switch 872 should be physical link 878. Access switch 872 (AS2) may also forward the packet traffic (as represented in this instance by dashed arrow 894) to server 862 (S2).

When server 862 (S2) replies back to server 863 (S3), data packet traffic for the communication flow (represented in this instance by solid arrow 895) may first travel to access switch 872 (AS2), where access switch may use link aggregation 876 (that includes physical links 877, 878) for upstream data packet traffic forwarding.

Where forwarding engine 875 of access switch 875 is not using a link selector data table (e.g. 879) for making link selections, forwarding engine 875 may employ a link selection algorithm, such as a hashing algorithm for making a forwarding link selection. Using such a scheme, the data, packet traffic may be sent out either on physical link 877 or physical link 878 depending on outcome of the hash function.

A non-optimal outcome may occur if physical link 877 is selected for the traffic packet forwarding. If physical link 877 is chosen by a selection scheme such as a hashing algorithm, the packet traffic (as represented in this instance by solid arrow 896) may arrive at distribution switch 881 (DS1) of distribution layer 880. Distribution switch 881 (DS1) may then re-forward the packet traffic (as represented in this instance by solid arrow 897) over ISL 885 to distribution switch 882 (DS2), which in turn may route the frame across to server 863 (S3) on the other sub-network (see data packet movements represented by solid arrows 898, 899). The forwarding of the reply traffic from access switch 872 to distribution switch 881 and then to distribution switch 882 (the default gateway) is non-optimal and can cause additional latency (e.g. in overburdening ISL 885).

In this example, using information from link selector data table 879, the extra hop may be avoided. When the transmission of data arrives at access switch 872 (e.g. in movement 895) for transport to distribution layer 880, forwarding engine 875 may match the fields of the received data packet against fields in the records of link selector data table 879. As the communication flow corresponding to the data packet had been sampled (and a record for the communication flow created in link selector data table 879), the record for the communication flow may indicate that physical link 878 should be chosen for the upstream transport. By choosing physical link 878 rather than physical link 877 in link aggregation 874, the extra transport hop (e.g. 897) may be avoided.

### ADDITIONAL CONSIDERATIONS

Though examples are presented herein for point multi-point link aggregation topologies such as an access device in an access layer forwarding data traffic in a link aggregation to multiple distribution layer switches, examples may be applied in other point multi-point link aggregation topologies. When distribution layer switches are connected via point multi-point to core layer switches, examples maybe implemented where the role of the access layer switch may be played by the distribution layer switch and the core layer switches may play the role of the distribution layer switches.

In another example, a device with a link selector table for making selections in a link aggregation may be applied in a network stacking solution. The networking technique known as stacking may involve interconnecting a set of devices (such as network processing cards or switches) with a cabling infrastructure that may allow the devices to function as one network device. In topologies where a second device is linked (e.g. through a link aggregation) across multiple members of such an interconnected stack, a device with a link selector data table for use in link selection in a link aggregation may be used to reduce the traffic overhead on the stacking backplane. In addition to the above, a device with a link selector data table for link selection in a link aggregation may be implemented, even if an aggregation is point-point, and not point multi-point. Accordingly, a point device (such as an access switch in an access layer) that maintains a flow table according to an embodiment of the present invention may not have to be aware of whether its aggregation links are point-point or point multi-point. Such a wider application may preclude the need for configuration overhead in the point device.

In addition to the above it is further noted that an embodiment may be implemented and used with point multi-point link aggregation topologies currently known and available with minimal intrusion to the basic topology. In some examples, no major design changes in the forwarding path in the point multi-point link aggregation system may be required except for the addition of link selector lookup logic. Further, given that a fallback link selection scheme (such as the commonly used hash algorithm) may be used to transport traffic across when there is no entry in the flow table for a given flow, there may be no loss of traffic or connectivity with such an embodiment even when flow table entries are being learned or when there is a churn in the distribution layer.

Unless specifically stated otherwise, as apparent from the discussions herein, it is appreciated that throughout the specification, discussions utilizing terms such as “selecting,” “evaluating,” “processing,” “computing,” “calculating,” “associating,” “determining,” “designating,” “allocating” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Examples described herein are not described with reference to any particular programming language, machine code, etc. It will be appreciated that a variety of programming languages, network systems, protocols or hardware configurations may be used to implement the teachings of the examples as described herein. In some examples, one or more methods may be stored as instructions or code in an article such as a memory device, where such instructions upon execution by a processor or computer result in the execution of a method described herein.

A computer program application stored in non-volatile memory or computer-readable medium (e.g. register memory, processor cache, RAM, ROM, hard drive, flash memory, CD ROM, magnetic media, etc.) may include code or executable instructions that when executed may instruct or cause a controller or processor to perform methods discussed herein. The non-volatile memory and/or computer-readable medium may be a non-transitory computer-readable media including all forms and types of memory and all computer-readable media except for a transitory, propagating signal.

While there have been shown and described fundamental novel features of the invention as applied to several embodiments, it will be understood that various omissions, substitutions, and changes in the form, detail, and operation of the illustrated embodiments may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

We claim:

1. A method for forwarding data packet traffic in a point multi-point link aggregation using a link selector data table, the method comprising:
receiving a data packet at a device having a point multi-point link aggregation (704) comprising a plurality of physical links;
determining whether data extracted from the received data packet can be matched to one of a plurality of records in a link selector data table, wherein each record comprises data to identify a communication flow and data to identify one of the physical links, each record being generated from a data packet sampled in a transmission coming to the device along ones of the physical links (714, 716); and
forwarding the received data packet on the physical link identified by the one record (722), wherein the extracted data is matched to one of the plurality of records.

2. The method of claim 1, comprising:
receiving a sample of a data packet received at the device (504);
extracting data from one or more fields of the sample;
determining from the extracted data if the sample was received in a transmission in-coming to the device along one of the physical links (506);
generating a record comprising the extracted data and an identifier of the physical link from which the data packet of the sample was received at the device (512), the extracted data uniquely identifying a communication flow for the data packet of the sample; and
storing the record in the link selector data table (514).

3. The method of claim 1, wherein the extracted data comprises a Destination-MAC-Address field (310), a Source-MAC-Address field (312), a Destination-IP-Address field (314) and a Source-IP-Address field (316).

4. The method of claim 1, wherein the extracted data comprises one or more a Destination-MAC-Address, Source-MAC-Address, Destination-IP-Address, Source-IP-Address, Source-Port and Destination-Port.

5. The method of claim 2, comprising generating the record, wherein the record further comprises a value to indicate an expiration of the record (322, 516).

6. The method of claim 1 comprising:
decrementing an age count value in each of the records of the link selector data table (608); and
deleting one of the records from the link selector data table, upon determining that the age count value of the record is equal to a pre-determined minimum floor value (612, 614).

7. The method of claim 2, said generating and storing the record comprising:
generating and storing the record when the link selector data table does not contain a record for the communication flow that is identified by the extracted data of the sample (510); and
updating an age counter value in one of the plurality of records, if the one record whose age counter value is updated identifies a communication flow that is identified by the extracted data of the sample (518).

8. A system for forwarding data packet traffic in a point multi-point link aggregation using a link selector data table, the system comprising:
a link selector data table (184) comprising a plurality of records (301, 302, 303), wherein each record comprises data (310, 312, 314, 316) to identify a communication flow and data (318) to identify one of a plurality of physical links (161, 162) of a point multi-point link aggregation (152) for a device (151), each record being generated from a data packet sampled in a transmission coming to the device along ones of the physical links;
a forwarding engine (182) comprising a processor (404) and link selection logic (410), the processor executing the link selection logic to determine whether data extracted from a received data packet can be matched to one of the plurality of records in the link selector data table, the forwarding engine further configured to forwarding the received data packet on the physical link identified by the one record, wherein the extracted data is matched.

9. The system of claim 8, comprising:
a management card (260) comprising an additional processor (408) and a table builder unit (264), the additional processor executing the table builder unit to receive data extracted from a sample of a data packet received at the device, to determine whether the sample of the extracted data was received in an in-coming transmission to the device along one of the physical links and to store a record (301, 302, 303) comprising the extracted data and an identifier of the physical link from which the sampled data packet was received in the link selector data table, the extracted data stored uniquely identifying a communication flow for the data packet of the sample.

10. The system of claim 9, the forwarding engine comprising a packet sampling unit (256), the processor executing the packet sampling unit to obtain the sample and forward the sample to the management card.

11. The system of claim 10, wherein the packet sampling unit uses one of the techniques of sFLOW, NETFLOW or IPFIX to generate the sample.

12. The system of claim 8, wherein the device is a device (151) in an access layer (110).

13. The system of claim 8, wherein the device is an access switch (151).

14. The system of claim 8, wherein the data packet is forwarded to a distribution switch (171, 172) in a distribution layer (120).

15. A non-transitory computer-readable medium (424) having stored thereon instructions, which when executed by a processor (404) cause the processor to perform the method of:
receiving a data packet at a device having a point multi-point link aggregation comprising a plurality of physical links (704);
determining whether data extracted from the received data packet can be matched to one of a plurality of records in a link selector data table, wherein each record comprises data to identify a communication flow and data to identify one of the physical links (714, 716);
forwarding the received data packet on the physical link identified by the one record (718), wherein the extracted data is matched to one of the plurality of records (722), and
forwarding the received data packet on one of the physical links of the link aggregation determined by using a hash function to identify the one physical link, wherein the extracted data in not matched to one of the plurality of records (720).
